(19) United States
(12) Patent Application Publication
(10) Pub. No.: US 2026/0222786 A1
(43) Pub. Date: Jul. 30, 2026

(54) EMERGENCY VEHICLE PROXIMITY WARNING SYSTEM AND METHOD

(71) Applicant: Lee F Hudson, Gulf Breeze, FL (US)

(72) Inventor: Lee F Hudson, Gulf Breeze, FL (US)

(21) Appl. No.: 19/039,587

(22) Filed: Jan. 28, 2025

(51) Int. Cl. H04W 4/90; G08G 1/09

(52) U.S. Cl. CPC H04W 4/90; G08G 1/091

(57) ABSTRACT

An alert system notifies motorists, via their cellphones, of an impending encounter with an emergency vehicle either with the vehicle in travel or at the emergency site. The system relies on the federal governments Emergency Alert System so that a dispatch center, being cognizant of the emergency vehicle’s location and direction of travel, sends out an Emergency Alert to cellphones that are in the expected area of vehicle-motorist interaction. An app, resident on the cellphone, squelches the message for stationary or slow-moving cellphones.

### BACKGROUND OF THE INVENTION

### 1. Field of the Invention

The present invention relates to a system and method that relay a message, via a cellphone, that an emergency vehicle is in proximity to the cellphone, either on the move or stationary at a scene of an emergency.

### 2. Background of the Prior Art

Emergency vehicles, by their definition, \need to proceed to the location of the emergency as quickly as possible. Most emergency vehicles, such as fire trucks, ambulances, and police cars, often travel well above the posted speed limit and run through red traffic lights on their way to the site of the emergency, typically with their emergency lights activated and a siren blaring. Motorists, seeing an emergency vehicle approaching with its lights activated and hearing the siren, give way. This includes pulling over to the side of the road to allow the emergency vehicle to pass by the motorist quickly – on two lane roads, motorists in both directions pull over – and to hold up at a traffic light, irrespective of the motorist’s light color, to allow the emergency vehicle to clear the intersection quickly.

However, even with these rules of the road for emergency vehicles, accidents happen. Motorists listening to a set of headphones especially in a relatively well sound insulated vehicle, talking on their cellphone, or worst, texting, may not be cognizant of the approaching emergency vehicle. A person caught up in a secondary function such as cellphone talking, in addition to their primary function of driving, has reduced situational awareness about their vehicle. With the motorist distracted and the driver of the emergency vehicle fixed on getting to the emergency and having certain expectations of motorists, upon the two vehicles meeting at a conflict point, sometimes a crash happens. As the emergency vehicle is typically travelling at an elevated rate of speed and some, such as fire trucks, being particularly large and heavy, often the crash is tragic resulting in serious injury or even death.

In order to gain a motorist’s attention, even a distracted motorist, software has been developed that alerts a motorist of a pending meeting with an emergency vehicle. As the source of the motorist’s secondary distraction is their cellphone this is a logical place to find a solution. One such system is the HASS Alert System produced by HAAS Alert Corporation of Chicago Illinois. This system uses WAZE navigation systems, produced by Waze Mobile Limited of Tel Aviv, Israel, a subsidiary of Google Corporation of Mountain View, California. A control box installed in the emergency vehicle broadcasts its location and its intended route of travel or, if stopped at the emergency site, the fact of that situation including the location. Motorists running the HAAS Alert app who are in the vicinity of the signal broadcast location receive the signal. The app determines if the emergency vehicle will encounter the motorist running the app or if the motorist will come upon the emergency vehicle that is stopped at the site of the emergency. If the app so determines, the app provides a warning to the motorist of the impending encounter with an emergency vehicle, the motorist’s vehicle location obtained by the GPS function of the cellphone. As the app uses a high-level interrupt to display its message, the motorist is alerted of the emergency vehicle’s impending presence even though their source of distraction is their cellphone.

While such systems appear to work relatively well, they suffer from two related drawbacks. A motorist must have the app installed on their cellphone and the emergency vehicle must be equipped with the control. In a world of tight budgets, this latter requirement may be problematic for many emergency vehicle operators. As such, such systems at best offer relatively modest penetration into the motorist universe. While some motorists will have this layer of protection in certain locations, better penetration is desired.

What is needed is a system that can alert a motorist of a pending encounter with an emergency vehicle, either while the emergency vehicle is traveling to the emergency or while stopped at the site of the emergency, which system can reach a large percentage of motorists. Such a system must communicate via the motorist’s cellphone, the source of much secondary distractions during driving.

### SUMMARY OF THE INVENTION

The emergency vehicle proximity warning system and method of the present invention addresses the aforementioned needs in the art by providing a system that warns motorists of their proximity to an emergency vehicle, either with the emergency vehicle in travel or at the emergency site. The emergency vehicle proximity warning system relies on an “app” that is preloaded on most phones, including virtually all phones produced by Apple Corporation of Cupertino, California and Samsung of Suwon-Si, South Korea. The emergency vehicle proximity warning system relies on the use of the federal government’s Wireless Emergency Alert system which sends out, among other alerts, AMBER Alerts for missing and endangered children and vulnerable adults, Emergency Alerts for imminent threats for threats that are current or emerging such as extreme weather or an active shooter, and Public Safety Alerts for less severe threats that are more distant or which may have already occurred. The Wireless Emergency Alert system broadcasts a short SMS message to cellphones in a desired area, being able to discriminate location to within 528 feet or 1/10 of a mile, more or less. As the software to receive these specific messages is resident on a large portion of cellphones, most motorists will receive the message if they are the intended target. While many cellphones give the option of disabling these messages, many cellphone owners do not so disable at least not the Emergency Alert portion of the system.

The emergency vehicle proximity warning system and method of the present is comprised of an in-vehicle (specifically within the emergency vehicle) navigation system (factor installed or aftermarket), the navigation system capable of calculating a route of travel between a first point and a second point and the navigation system also calculating the navigation system’s current position along the route or stopped at a site. The present invention also includes interactions with emergency alert broadcast system that can broadcast emergency alerts to cellphones within a predefined geolocation. The navigation system transmits its current position to the emergency alert broadcast system and the emergency alert broadcast system broadcasts a text alert message to cellphones within a geolocation that is in proximity to the current position, the proximity being within a first set distance from the current position. The first set distance is dynamically changeable. The emergency alert broadcast system also broadcasts the alert message to all the cellphones within proximity of the route, the proximity being a second set distance from the route and a third set distance from the current position, that is, if the route is long, the message is only transmitted to cellphones that are with a target zone of the emergency vehicle’s current position. The cellphones are capable of squelching the received message, particularly if the cellphone, via its internal calculations, has determined that it has not traveled above a threshold speed in the immediate past set amount of time, indicating that the holder of the cellphone is either at rest or is moving sufficiently slowly as to not need to be warned about approaching emergency vehicle in the vicinity. The cellphone issues an audible alert upon receipt of the message. The message may include a description of the current position and/or a description of at least a portion of the route of travel of the emergency vehicle.

### BRIEF DESCRIPTION OF THE DRAWINGS

FIG. 1 is a schematic view of the emergency vehicle proximity warning system and method of the present invention in use.

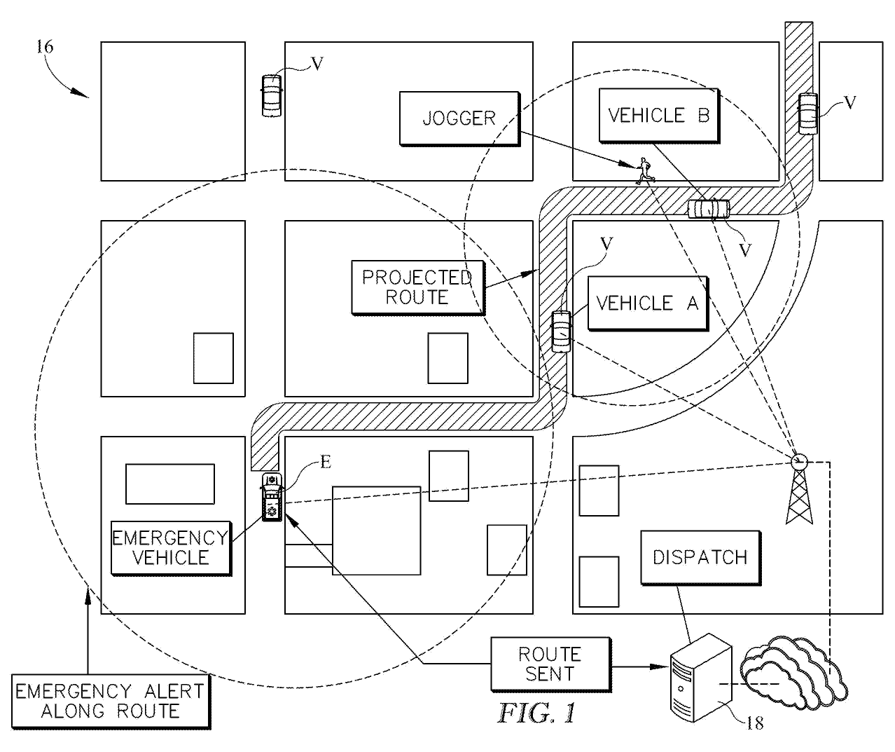

FIG. 2 is a schematic view of the emergency vehicle proximity warning system and method as the emergency vehicle continuous along its route.

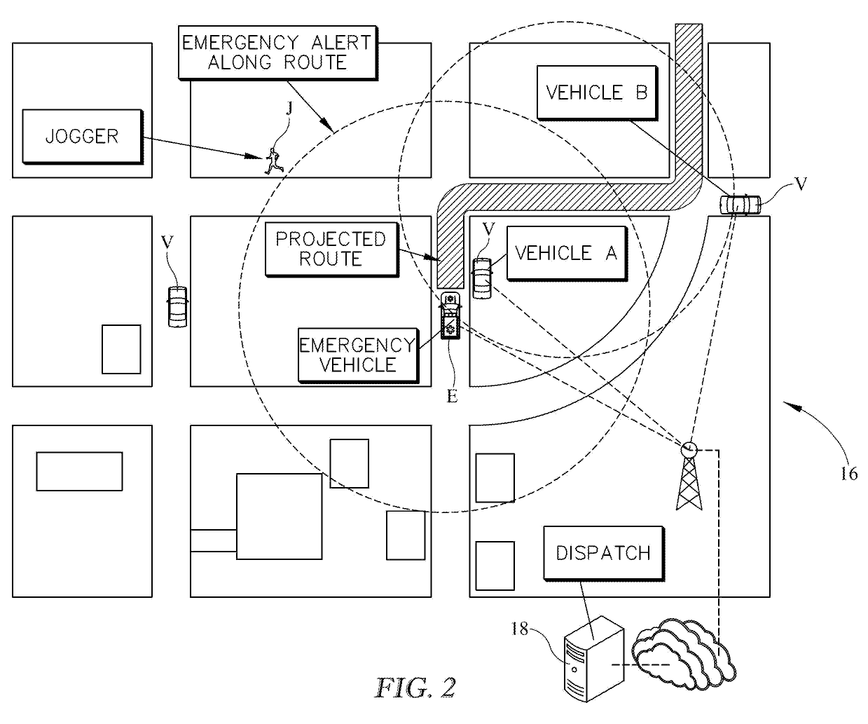

FIG. 3 is a flowchart of the squelching app resident on a cellphone which app determines whether or not to squelch the received message for that particular cellphone.

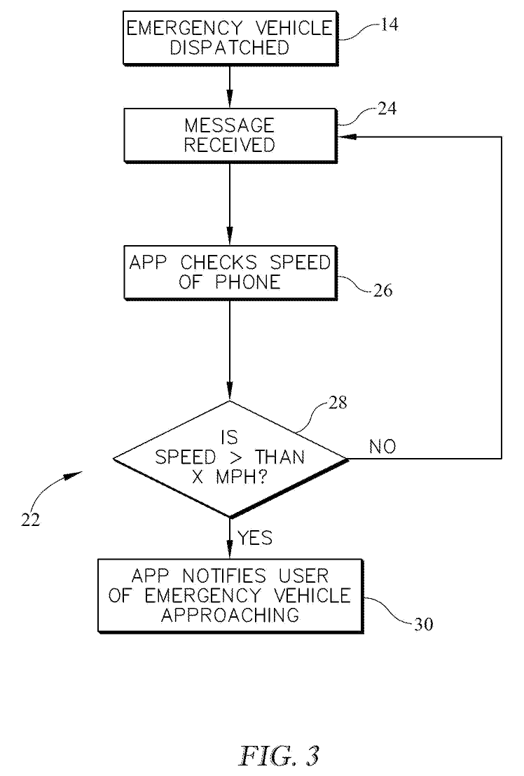

FIG. 4 is an environmental view of some of the potential recipients of the output of the emergency vehicle proximity warning system and method.

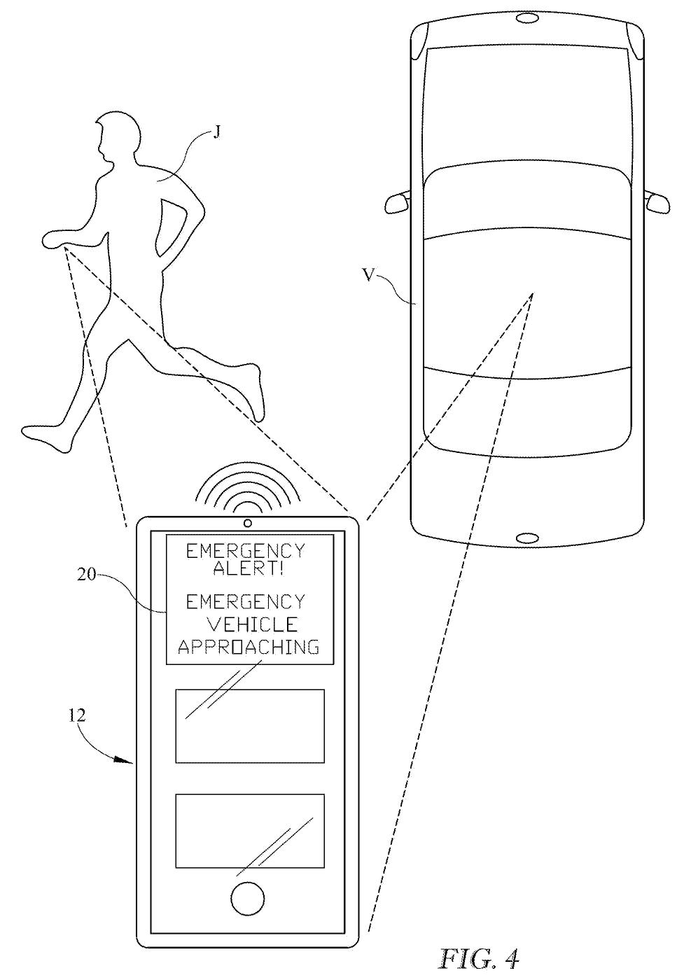

Similar reference numerals refer to similar parts throughout the several views of the drawings.

### DESCRIPTION OF THE PREFERRED EMBODIMENT

Referring now to the drawings, it is seen that the emergency vehicle proximity warning system of the present invention is comprised of several components, namely the Emergency Alert component of the federal government’s Emergency Alert System, the emergency vehicle E including its onboard navigation system and its communication system that communicates with its dispatch center (a large portion of emergency vehicle dispatch centers currently have access to and the ability to use the Emergency Alert System), a cellphone 12 and an app residing on the cellphone 12, which app can be integrated into the overall Emergency Alert System software that is resident on the cellphone 12 when delivered from the factory or can be an add on app.

When a modern emergency vehicle E is dispatched 14 to an emergency, the system activates, a map 16 to the site of the emergency is provided to the emergency vehicle’s driver on an appropriate display within the emergency vehicle E, via appropriate software such as that provided by the aforementioned Waze Mobile Limited in order to allow the driver to be able to quickly get to the emergency site, basically navigation software and hardware, often sophisticated to account for traffic conditions, road closures, etc. This route information is relayed to a computer system 18 at the dispatch center that dispatched the emergency vehicle E via the in-vehicle communication system that interacts with the vehicle’s navigation system. The computer system 18 at the dispatch center may be the exiting computer system upon which the Emergency Alert System is resident, or may be a separate computer system that interacts with the Emergency Alert Computer system’s computer. As the emergency vehicle E travels to the emergency site, its current position is broadcast back to the dispatch center’s computer system 18 as is any change in the route previously calculated by the navigation software should road or other conditions mandate a course of travel change or simply the driver of the emergency vehicle E deciding to take a modified route to the emergency or the site of the emergency changes. If the navigation system does not calculate a route to the emergency, which may occur if law enforcement is chasing a suspect or the emergency vehicle is stopped at the emergency site, then emergency vehicle proximity warning system simply uses the vehicle’s current position, as calculated by the navigation system, which current position is broadcast back to the dispatch center’s computer system 18 and used for geolocation determination as more fully discussed below.

The dispatch center’s computer system 18 is aware of the position of the emergency vehicle E and often its intended course of travel. The dispatch center’s computer system 18, via the emergency vehicle proximity warning system and method, dispatches an Emergency Alert message 20 via the Emergency Alert System to cellphones 12 based on the current position of the emergency vehicle E and also based on the intended path of travel of the emergency vehicle E, if an intended path of travel exists (law enforcement chasing a suspect may not have a route map 16 or the emergency vehicle E can be stationary at the site of the emergency) accounting for straightforward travel and anticipated turns as calculated by the vehicle’s navigation system and transmitted back to the dispatch center’s computer system 18. At a minimum, cellphones 12 within approximately 528 feet of the approaching emergency vehicle E receive the message (this 528 foot number being the current geolocation refinement state of the art, but can change as technology progresses), however, the system allows a user to increase this geo-targeting range depending on the location whereat the emergency vehicle proximity warning system and method is deployed. 528 feet, or 1/10 of a mile geolocation discrimination might be sufficient in a dense urban area such as New York City. In the suburbs, with faster roads, the effective target range may be cellphones within ½ mile, for example, of the emergency vehicle E, and in rural areas, maybe 2 miles, for example, might be the more appropriate target distance. The emergency vehicle proximity warning system allows for dynamic change of the distance so that if an emergency vehicle E travels from a dense urban area to a less dense area, or vice versa, the target distance of the broadcast Emergency Alert message can change accordingly. If the emergency vehicle E is stopped at the site of the emergency, then the emergency vehicle proximity warning system and method dispatches an omnidirectional message, again the geo-targeting range being dependent on the location of the emergency. As seen, the message is also sent to cellphones 12 behind the emergency vehicle in order to warn drivers that might be approaching the emergency vehicle from behind. As also seen, the message 20 is also sent to points along the intended route of travel, which points do not necessarily radiate out from the emergency vehicle’s current position. If the emergency vehicle E does not have an intended route of travel – no navigation system output – as may be the case of law enforcement chasing a suspect, then the emergency vehicle proximity warning system broadcasts its emergency message 20 solely based on the emergency vehicle’s current position.

The Emergency Alert message 20 is broadcast at regular intervals, which may be time dependent but may also be mount of travel of the emergency vehicle E dependent, or a combination of the two, accounting for the environment (urban, suburban, rural), in which the emergency vehicle E is traveling. If the emergency vehicle E deviates from the route assigned by its navigation system (or simply turns when no route is available), then a new Emergency Alert message 20 is broadcast for users along the modified route and again at regular intervals per the configuration of the system.

The message 20 dispatched, by being SMS, can be up to 360 characters, and can be user defined, but is, advantageously short, such as “emergency vehicle traveling north on Main Street” or “emergency vehicle stopped at 327 Main Street,” or even something as simple as “emergency vehicle approaching.” The message 20 is sent as an SMS message.

The app 22 resident on the cellphone 12 has the capability to stop the Emergency Alert message 20 from being displayed when the message 20 is received 24 by a cellphone 12. Specifically, the app continuously measures the rate of travel (speed) 26 of the cellphone 12. If a cellphone 12 does not travel above a certain rate of travel 28, say 3 miles per hours in a given amount of time, say 90 seconds, then the app determines that the person is stationary (such as being at home or at a restaurant) and not travelling in a vehicle (car, bicycle, etc.,) or is traveling sufficiently slowly, such as a pedestrian walker, and therefore does not need to receive the Emergency Alert message 20 and the app blocks the message 20 from being displayed on the cellphone 12, or at least the audio portion of the message is silenced. Above the threshold speed are passengers in motorized vehicles V, bicycles, and joggers J who do not have the message 20 squelched. If the app determines that the cellphone 12 has exceeded the threshold speed, indicating a faster moving person, then the message 20 is displayed 30 on the cellphone 12. The app 22 can be configured to remain idle and not block any messages 20 as some people, especially in suburban and rural settings may want to be cognizant of the fact that an emergency vehicle has travelled past their homes or businesses. The app 22 can be factory installed and interact with the Emergency Alert subsystem or can simply be integrated into the overall Emergency Alert subsystem on the cellphone 12, and can be downloaded onto existing phones or cellphones that did not have the app factory installed.

The emergency vehicle proximity warning system and method does not otherwise affect the current functioning of the Emergency Alert System software factory installed on the cellphone 12.

While the invention has been particularly shown and described with reference to an embodiment thereof, it will be appreciated by those skilled in the art that various changes in form and detail may be made without departing from the spirit and scope of the invention.

I claim:

1. An alert system comprising:
an in-vehicle navigation system, the navigation system calculates a route of travel between a first point which is a current position of the navigation system and a second point and the navigation system also calculating the navigation system’s current position, the current position of the in-vehicle navigation system calculated by the in-vehicle navigation system via input from a signal sent by a GPS to the in-vehicle navigation system;
an emergency alert broadcast system;
at least one cellphone capable of receiving emergency messages from the emergency alert broadcast system; and
wherein the navigation system transmits its current position and the route of travel commencing from the current position to the emergency alert broadcast system and the emergency alert broadcast system broadcasts a text alert message to at least some of the cellphones within a first geolocation that is in proximity to the current position, the proximity being within a first set distance from the current position, and the emergency alert broadcast system broadcasts the text alert message to at least some of the cellphones within a second geolocation that is in proximity to at least a portion of the route of travel position, the proximity being a second distance from the portion of the route of travel, which second distance is not necessarily the same as the first distance, the portion of the route of travel extending contiguously from the current position.

2. The alert system as in claim 1 wherein the first set distance is dynamically changeable.

3. The alert system as in claim 1 wherein at least one of the cellphones that receives the alert message squelches the alert message.

4. The alert system as in claim 1 wherein the at least one cellphone continuously calculates a the rate of travel of the cellphone and upon receipt of the message from the emergency alert broadcast system, the cellphone determines a maximum rate of travel for an immediately previous set amount of time and if the rate of travel fails to exceed a preset threshold amount, the cellphone squelches the alert message.

5. The alert system as in claim 1 wherein the cellphone issues an audible alert upon receipt of the alert message.

6. The alert system as in claim 1 wherein the alert message includes a description of the current position.

7. The alert system as in claim 1 wherein the alert message includes a description of at least a portion of the route.

8. A method to send an alert message comprising the steps of:
having an in-vehicle navigation system that calculates a route of travel between a first point, which is a current position of the in-vehicle navigation system and a second point and the navigation system also calculating the navigation system’s current position via input from a signal sent by an GPS to the in-vehicle navigation system;
having the navigation system transmit its current position to an emergency alert broadcast system; and
having the emergency alert broadcast system broadcast a text alert message to a series of cellphones that are capable of receiving emergency messages from the emergency alert broadcast system within a first geolocation that is in proximity with the current position, the proximity being within a first set distance from the current position and the emergency alert broadcast system broadcasts the text alert message to at least some of the cellphones within a second geolocation that is in proximity to at least a portion of the route of travel position, the proximity being a second distance from the portion of the route of travel, which second distance is not necessarily the same as the first distance, the portion of the route of travel extending contiguously from the current position.

9. The method as in claim 8 wherein the first set distance is dynamically changeable.

10. The method as in claim 8 wherein at least one of the cellphones squelches the alert message.

11. The method as in claim 8 further comprising the steps of:
having each cellphone continuously calculate the rate of travel of the respective cellphone; and
upon receipt of the alert message from the emergency alert broadcast system, having the cellphone determine it a maximum rate of travel for an immediately previous set amount of time and if the rate of travel fails to exceed a preset threshold amount, having the cellphone squelch the alert message.

12. The method as in claim 8 further comprising the step of having the cellphone issues an audible alert upon receipt of the alert message.

13. The method as in claim 8 wherein the alert message includes a description of the current position.

14. The method as in claim 8 wherein the alert message includes at least a description of at least a portion of the route.
